(19) United States
(12) Patent Application Publication
(10) Pub. No.: US 2015/0067493 A1
(43) Pub. Date: Mar. 5, 2015

(54) METHOD OF MODIFYING TEXT INPUT FROM USER AND ELECTRONIC DEVICE THEREFOR

(71) Applicant: Samsung Electronics Co., Ltd., Gyeonggi-do (KR)

(72) Inventors: Hee-Soo Son, Gyeonggi-do (KR); Jung-Sik Kim, Seoul (KR); Kee-Hwan Seol, Gyeonggi-do (KR); Seong-Joon Jeon, Gyeonggi-do (KR)

(21) Appl. No.: 14/476,641

(22) Filed: Sep. 3, 2014

(30) Foreign Application Priority Data
Sep. 3, 2013 (KR) 10-2013-0105764

(51) Int. Cl. G06F 17/24; G06F 3/0484; G06F 3/0488

(52) U.S. Cl. CPC G06F 17/24; G06F 3/04886; G06F 3/04842
USPC 715/271

(57) ABSTRACT

A method for operating an electronic device with a display includes: displaying a virtual keypad on a screen of the display; receiving one or more characters from a user through the virtual keypad; displaying the one or more characters on the screen; displaying one or more recommended words at a location close to the virtual keypad on the screen based on at least some of the one or more characters; displaying a first key on the screen; maintaining the one or more characters on the screen when a user input for selecting the first key is received; and removing the recommended words from the screen. Furthermore, other embodiments can be made.

### CROSS-REFERENCE TO RELATED APPLICATION(S) AND CLAIM OF PRIORITY

The present application is related to and claims the priority under 35 U.S.C. §119(a) to Korean Application Serial No. 10-2013-0105764, which was filed in the Korean Intellectual Property Office on Sep. 3, 2013, the entire content of which is hereby incorporated by reference.

### TECHNICAL FIELD

The present disclosure relates to a method of modifying a text input from a user and an electronic device therefor.

### BACKGROUND

A recent mobile terminal supporting a touch input is provided with a text input unit that can receive an input of a text from a user. The user inputs words or symbols to the mobile terminal through the text input unit, and the mobile terminal stores the words or symbols input from the user in a storage unit within the mobile terminal or forwards the words or symbols to another mobile terminal.

The user, when inputting a word to the mobile terminal through the text input unit, may incorrectly input the word. In this case, the user modifies the incorrectly input word by deleting the incorrect word and inputting a new word through the text input unit.

### SUMMARY

In order to modify the incorrectly input word, the user moves a cursor to a position of the incorrect word, deletes the incorrect word, and inputs the new word. However, when a number of words have been incorrectly input, such a method is time consuming since the user has to move the cursor to a position of the incorrect words to modify them one by one. Particularly, when the user wants to transfer or store information through a rapid input, the aforementioned method may be inefficient due to a lot of time being consumed to modify text, and may not reduce the time.

To address the above-discussed deficiencies, it is a primary object to provide a method of modifying a text input from a user and an electronic device therefor.

In accordance with one aspect of the present disclosure, a method for operating an electronic device with a display is provided. The method includes: displaying a virtual keypad on a screen of the display; receiving one or more characters from a user through the virtual keypad; displaying the one or more characters on the screen; displaying one or more recommended words at a location close to the virtual keypad on the screen based on at least some of the one or more characters; displaying a first key on the screen; maintaining the one or more characters on the screen when a user input for selecting the first key is received; and removing the recommended words from the screen.

In accordance with another aspect of the present disclosure, a method for operating an electronic device with a display is provided. The method includes: displaying a virtual keypad on a screen of the display; receiving one or more characters from a user through the virtual keypad; displaying the one or more characters on the screen; displaying one or more recommended words on the screen based on at least some of the one or more characters; displaying a selection key on the screen; and changing the one or more characters to a recommended word having a highest similarity to the one or more characters among the recommended words when a user input for selecting the selection key is received.

In accordance with another aspect of the present disclosure, a method for operating an electronic device with a display is provided. The method includes: receiving one or more characters from a user; determining the characters as a temporary text; determining whether the temporary text is correct; determining and displaying recommended words corresponding to the temporary text when the temporary text is not correct; determining whether a user input for selecting one of the recommended words has been received; and changing the temporary text to a recommended word depending on the user input and displaying the recommended word, when the user input for selecting one of the recommended words has been received.

In accordance with another aspect of the present disclosure, an electronic device with a display is provided. The electronic device includes: a screen configured to display a virtual keypad, and receive one or more characters from a user through the virtual keypad; and a controller configured to control the screen to display the one or more characters on the screen, control the screen to display one or more recommended words at a location close to the virtual keypad based on at least some of the one or more characters, control the screen to display a first key, control the screen to maintain the one or more characters when a user input for selecting the first key is received, and remove the recommended words from the screen.

In accordance with another aspect of the present disclosure, an electronic device with a display is provided. The electronic device includes: a screen configured to display a virtual keypad, and receive one or more characters from a user through the virtual keypad; and a controller configured to control the screen to display the one or more characters, control the screen to display one or more recommended words based on at least some of the one or more characters, control the screen to display a selection key, and change the one or more characters to a recommended word having a highest similarity to the one or more characters among the recommended words when a user input for selecting the selection key is received.

In accordance with another aspect of the present disclosure, an electronic device with a display is provided. The electronic device includes: a keypad configured to receive one or more characters from a user; a screen configured to display the one or more characters; and a controller configured to control the screen to determine the one or more characters as a temporary text, determine whether the temporary text is correct, determine recommended words corresponding to the temporary text when the temporary text is not correct, control the screen to display the recommended words, determine whether a user input for selecting one of the recommended words has been received, change the temporary text to a recommended word depending on the user input, when the user input for selecting one of the recommended words has been received, and control the screen to display the changed recommended word.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a block diagram illustrating a configuration of an electronic device according to an embodiment of the present disclosure;

FIG. 2 is a front perspective view of an electronic device according to an embodiment of the present disclosure;

FIG. 3 is a rear perspective view of the electronic device according to the embodiment of the present disclosure;

FIG. 4 is a block diagram illustrating a configuration of the controller included in the electronic device illustrated in FIG. 1;

FIG. 5 is a flowchart illustrating an example of a method in which the electronic device illustrated in FIG. 1 modifies a text input from a user;

FIG. 6 is a flowchart illustrating another example of a method in which the electronic device illustrated in FIG. 1 modifies a text input from a user;

FIG. 7 illustrates an example in which the electronic device illustrated in FIG. 1 modifies a text input from a user;

FIG. 8 illustrates another example in which the electronic device illustrated in FIG. 1 modifies a text input from a user;

FIGS. 9A and 9B illustrate another example in which the electronic device illustrated in FIG. 1 modifies a text input from a user;

FIGS. 10A and 10B illustrate another example in which the electronic device illustrated in FIG. 1 modifies a text input from a user;

FIG. 11 is a flowchart illustrating a method of operating an electronic device according to an embodiment of the present disclosure;

FIG. 12 is a flowchart illustrating a method of operating an electronic device according to another embodiment of the present disclosure; and

FIG. 13 is a flowchart illustrating a method of operating an electronic device according to another embodiment of the present disclosure.

### DETAILED DESCRIPTION

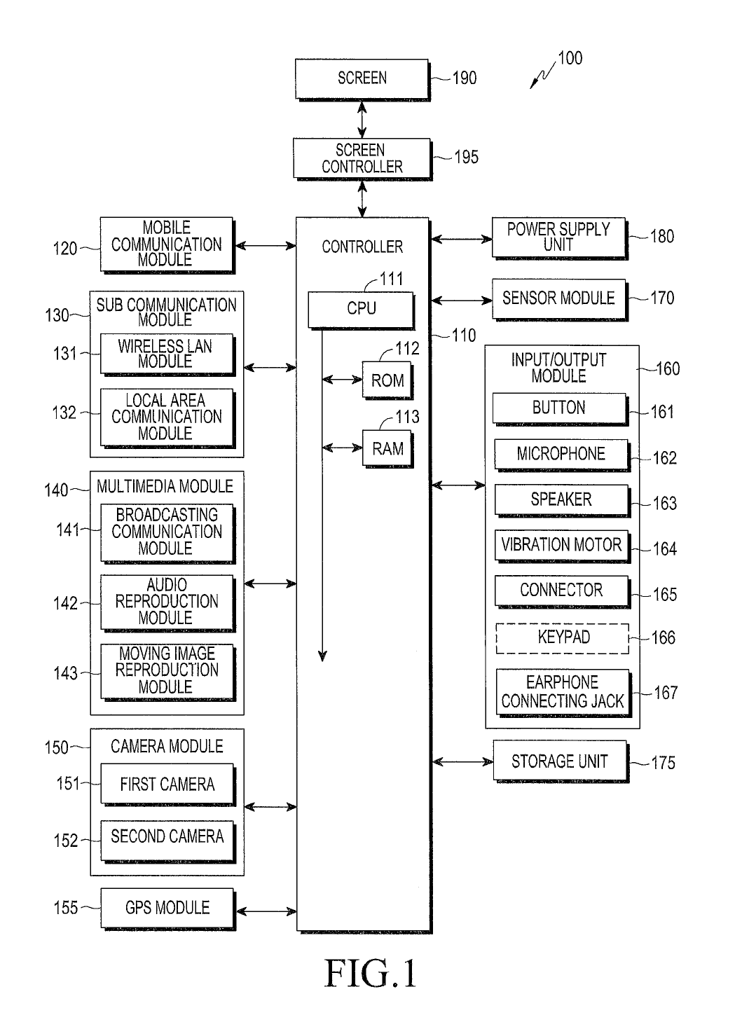

FIGS. 1 through 13, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic device. Hereinafter, exemplary embodiments of the present disclosure will be described in detail with reference to the accompanying drawings. Although particular matters such as specific configuration elements are shown in the following description, it will he obvious to those skilled in the art to which the present disclosure pertains that the particular matters are provided only to help a comprehensive understanding of the present disclosure, and various modifications and changes can be made within the scope of the present disclosure.

FIG. 1 is a block diagram illustrating a configuration of an electronic device according to an embodiment of the present disclosure.

Referring to FIG. 1, an electronic device 100 may include a controller 110, a mobile communication module 121, a storage unit 175, and a screen 190, and may further include at least one of a sub-communication module 130, a multimedia module 140, a camera module 150, an input/output module 160, a sensor module 170, a power supply unit 180, and a screen controller 195.

The controller 110 may include a Central Processing Unit (CPU) 111, a Read Only Memory (ROM) 112 storing a control program for controlling the electronic device 100, and a Random Access Memory (RAM) 113 used as a storage area for storing signals or data input from the outside of the electronic device 100 or for tasks performed in the electronic device 100. The CPU 111 may include a single core, a dual core, a triple core, or a quad core. The CPU 111, the ROM 112, and the RAM 113 may be connected with each other through internal buses.

The controller 110 may control the mobile communication module 121, the sub-communication module 130, the multimedia module 140, the camera module 150, a Global Positioning System (GPS) 155, the input/output module 160, the sensor module 170, the storage unit. 175, the power supply unit 180, the screen 190, and the screen controller 195.

The controller 110 may control various types of content being displayed through the screen 190 or displaying of the content, by controlling the screen 190. The controller 110 may control the electronic device 100 to perform an operation according to a touch input detected through the screen 190, namely, a user input. When a touch input of touching at least one point is input through the screen 190, the controller 110 controls the electronic device 100 to perform an operation corresponding to the touch input.

The controller 110 according to the embodiment of the present disclosure may receive an input of a text, namely, a character or word from a user according to a user input through the input/output module 166 or the screen 190. According to the embodiment, the controller 110 may determine the character or word corresponding to the user input and control the screen 190 to display the corresponding character or word. When the character or word is determined, the controller 110 may determine a specific word including the corresponding character or word. For example, assuming that “sta” is being displayed on the screen 190 and a user inputs “r” as a character following “sta”, the controller 110 may determine “sta” and “r” as a word “star”.

According to the embodiment, the controller 110 may extract a word similar to at least one text according to the user input as a recommended word from the storage unit 175 in real time. For example, assuming that characters according to the user input are “sta” in an input order thereof, the controller 110 may extract “star” as a word similar to “sta”, namely, a recommended word from the storage unit 175, and control the screen 190 to display the extracted word as the recommended word. That is, when “sta” is input by the user, the controller 110 may extract “star” as the recommended word from the storage unit 175 and control the screen 190 to display “star” as the recommended word. According to an embodiment, the controller 110 may extract a plurality of words as the recommended word from the storage unit 175. For example, the controller 110 may extract “star”, “stand”, “start”, “state”, “stage”, “station”, “starship”, and the like as recommended words corresponding to “sta”, and display the recommended words through the screen 190.

The extraction of the recommended words as described above may be performed in real time. For example, when “sta” is being input by a user, the controller 110 may extract “star”, “stand”, “start”, “state”, “stage”, “station”, “starship”, and the like as the recommended words. Thereafter, when “r” is input according to a user input, this means that “star” is input to the electronic device 100, and therefore, the controller 110 may extract “star”, “start”, “stare”, “startle”, “starship”, and the like as recommended words corresponding to “star” from the storage unit 175 again. Furthermore, according to an embodiment, the controller 110 may control the screen 190 to display the recommended words according to a similarity to the input characters. For example, the controller 110 may control the screen 190 to display the recommended words in a descending order of the similarity.

According to an embodiment, the controller 110 may determine whether a word being currently input by a user is a correct word. For example, it is assumed that although a user wants to input “star”, “staw” is mistakenly input instead of “star”. The controller 110 may determine whether “staw” corresponds to a word stored in the storage unit 175, and when it is determined that “staw” has not been stored in the storage unit 175, may extract recommended words corresponding to “staw”.

When the screen 190 displays at least one recommended word, the controller 110 may determine whether a user input has been input for selecting any one of the recommended words. When it is determined that the user input has been input, the controller 110 may substitute the recommended word selected by the user for the word input by the user. Furthermore, the controller 110 may control the screen 190 to display the recommended word selected by the user instead of the word input by the user.

The input/output module 160 may include at least one of a plurality of buttons 161, a microphone 162, a speaker 163, a vibration motor 164, a connector 165, and a keypad 166. The input/output module 160 according to the embodiment of the present disclosure may receive an input of a text, namely, characters or a word from a user.

The buttons 161 may be formed on a front surface, a side surface, or a rear surface of a housing of the electronic device 100, and may include at least one of a power/lock button (not illustrated), a volume button (not illustrated), a menu button, a home button, a back button, and a search button 161.

The microphone 162 receives an input of voice or sound to generate an electrical signal under the control of the controller 110. The microphone 162 according to the embodiment of the present disclosure may receive an input of voice from a user to generate a voice signal.

The speaker 163 may output sounds corresponding to various signals (e.g., a radio signal, a broadcasting signal, a digital audio file, a digital video file, photographing or the like) of the mobile communication module 121, the sub-communication module 130, the multimedia module 140, or the camera module 150 to the outside of the electronic device 100 under the control of the controller 110. The speaker 163 may output sounds corresponding to functions performed by the electronic device 100 (e.g., a button control sound or a ring back tone corresponding to a telephone call). One or more speakers 163 may be arranged at a proper position or positions of the housing of the electronic device 100.

The vibration motor 164 may convert an electrical signal into mechanical vibration under the control of the controller 110. For example, the electronic device 100 in a vibration mode operates the vibration device 164 when a voice call is received from another device (not illustrated). One or more vibration motors 164 may be provided within the housing of the electronic device 100. The vibration motor 164 may operate in response to a user's touch action on the screen 190 and a continuous movement of the touch on the screen 190.

The connector 165 may be used as an interface for connecting the electronic device 100 with an external device (not illustrated) or a power source (not illustrated). The electronic device 100 may transmit data stored in the storage unit 175 of the electronic device 100 to an external device (not illustrated) or may receive data from the external device (not illustrated) through a wired cable connected to the connector 165 under the control of the controller 110. Furthermore, the electronic device 100 may receive power from a power source (not illustrated) through the wired cable connected to the connector 165, or may charge a battery by using the power source.

The keypad 166 may receive a key input from a user for control of the electronic device 100. The keypad 166 includes a physical keypad (not illustrated) formed in the electronic device 100 or a virtual keypad (not illustrated) displayed on the screen 190. The physical keypad (not illustrated) formed in the electronic device 100 may be excluded according to a capability or structure of the electronic device 100. The keypad 166 according to the embodiment of the present disclosure may receive an input of a text, namely, characters or a word from a user.

Earphones (not illustrated) may be inserted into an earphone connecting jack 167 and thereby, connected with the electronic device 100.

The storage unit 175 may store signals or data input/output to correspond to an operation of the mobile communication module 121, the sub-communication module 130, the multimedia module 140, the camera module 150, the GPS module 155, the input/output module 160, the sensor module 170, and the screen 190 under the control of the controller 110. The storage unit 175 may store a control program and applications for control of the electronic device 100 or the controller 110. Furthermore, the storage unit 175 according to the embodiment of the present disclosure may be implemented in the form including a word database (DB) 412, and the word DB 412 may include, for example, a word dictionary.

The term “storage unit” is used as a term which refers to a random data storage device such as the storage unit 175, the ROM 112 and the RAM 113 within the controller 110, or a memory card (not illustrated) (e.g., a Secure Digital (SD) card or memory stick) mounted on the electronic device 100. The storage unit 175 may include a non-volatile memory, a volatile memory, a Hard Disc Drive (HDD), or a Solid State Drive (SSD).

The screen 190 may display various types of data stored for control of the electronic device 100. According to an embodiment, the screen 190 may be implemented in the form of a touch screen to receive, from a user, a user input (a touch input) generated by contact between the user's body part (e.g., a finger) and the screen 190. Furthermore, the screen 190 may provide a user with a user interface corresponding to various services (e.g., a telephone call, data transmission, broadcast, and photography). The screen 190 may transmit, to the screen controller 195, an analog signal (a touch input) corresponding to at least one touch input to the user interface. The touch screen 190 may receive at least one touch through a user's body part (e.g., fingers including a thumb) or a touchable input unit (e.g., a stylus pen). Furthermore, the screen 190 may receive a continuous movement of one touch among at least one touch. The screen 190 may transmit, to the screen controller 191, an analog signal corresponding to the continuous movement of the touch input thereto.

In the present disclosure, a touch is not limited to contact between the screen 190 and a user's body or a touchable input unit, and may include non-contact. That is, the screen 190 may also detect a user input not directly contacting the screen 190 as the touch. According to an embodiment, a distance between the screen 190 and an input unit in the contactless manner may vary depending on a capability or structure of the electronic device 100. For example, a distance between the screen 190 and a user's body or touchable input unit may be 3 cm or less, and may also be 3 cm or greater according to another embodiment.

According to an embodiment, the screen 190 may display a virtual keypad to thereby receive an input of a text, namely, characters or a word from a user. The screen 190 may display the text input from the user and display recommended words corresponding to the word input by the user under the control of the controller 110.

The screen 190 may be implemented, for example, in a resistive type, a capacitive type, an infrared type, an acoustic wave type, an Electra-Magnetic (EM) type, an Electro-Magnetic Resonance (EMR) type, or the like.

The screen controller 195 may convert an analog signal received from the screen 190 to a digital signal (e.g., X and Y coordinates) and transmit the digital signal to the controller 110. The controller 110 may control the screen 190 using the digital signal received from the screen controller 195. Furthermore, the screen controller 195 may be included in the controller 110.

According to an embodiment, the screen controller 195 may also extract coordinates on the screen 190 corresponding to a proximity sensing input sensed by the sensor module 170. For example, it is assumed that a proximity sensing input for selecting a point (a first point) within a predetermined range close to the screen 190 has been sensed through the sensor module 170. Furthermore, it is assumed that the proximity sensing has been implemented in the capacitive type. The sensing module 170 may sense a change in electrostatic capacity generated within a predetermined range of the screen 190, and the controller 110 may control the screen controller 195 to extract coordinates of a point (a second point) on the screen 190 corresponding to the point (the first point) at which the electrostatic capacity has been changed. For example, the second point may be a point on the screen 190 which is located to be closest to the first point.

The mobile communication module 121 may allow the electronic device 100 to be connected with an external device using at least one antenna (not illustrated) under the control of the controller 110. The electronic device 100 and the external device may be connected through mobile communication. The mobile communication module 121 may transmit/receive a wireless signal for a voice call, a video call, a Short Message Service (SMS) or a Multimedia Message Service (MMS) to/from a mobile phone (not illustrated) with phone numbers input to the electronic device 100, a smart phone (not illustrated), a tablet PC, or other devices (not illustrated).

The sub-communication module 130 may include at least one of a wireless LAN module 131 and a short range communication module 132, and the multimedia module 140 may include at least one of a broadcasting communication module 141, an audio reproducing module 142, and a video reproducing module 143. The camera module 150 may include at least one of a first camera 151 and a second camera 152, and the input/output module 160 may include at least one of the buttons 161, the microphone 162, the speaker 163, the vibration motor 164, the connector 165, and the keypad 166.

The sub-communication module 130 may include at least one of the wireless LAN module 131 and the short. range communication module 132. For example, the sub-communication module 130 may include the wireless LAN module 131 or the short-range communication module 132. Alternatively, the sub-communication module 130 may include both the wireless LAN module 131 and the short-range communication module 132.

The wireless LAN module 131 may be connected to the Internet in a place where a wireless Access Point (AP) (not illustrated) is installed, under the control of the controller 110. That is, the wireless LAN module 131 may support a wireless internet connection of the electronic device 100. The wireless LAN module 131 may support a wireless LAN standard (IEEE802.11x) of the Institute of Electrical and Electronics Engineers (IEEE). The short range communication module 132 may wirelessly perform short range communication between the electronic device 100 and an image forming device (not illustrated) under the control of the controller 110. A short range communication scheme may include a Bluetooth communication scheme, an infrared Data Association (IrDA) communication scheme, a Wi-Fi Direct communication scheme, a Near Field Communication (NFC) scheme, and the like.

The electronic device 100 may include at least one of the mobile communication module 121, the wireless LAN module 131, and the short range communication module 132 according to a capability thereof. For example, the electronic device 100 may include a combination of the mobile communication module 121, the wireless LAN module 131, and the short range communication module 132 according to the capability thereof.

The multimedia module 140 may include the broadcasting communication module 141, the audio reproducing module 142, or the video reproducing module 143. The broadcasting communication module 141 may receive a broadcasting signal (e.g., a TV broadcasting signal, a radio broadcasting signal, or a data broadcasting signal) or broadcasting additional information (e.g., Electric Program Guide (EPS) or Electric Service Guide (ESG)) which are transmitted from a broadcasting station, through a broadcasting communication antenna (not illustrated) under the control of the controller 110. According to an embodiment, the broadcasting communication module 141 may output content data received through the mobile communication module 121 to the screen 190. The audio reproducing module 142 may reproduce a stored or received digital audio file (e.g., a file having a file extension of mp3, wma, ogg, or way) under the control of the controller 110. The video reproduction module 143 may reproduce a stored or received digital video file (e.g., a file having a file extension of mpeg, mpg, mp4, avi, mov, or mkv) under the control of the controller 110. The video reproducing module 143 may reproduce a digital audio file.

The multimedia module 140 may include the audio reproducing module 142 and the video reproducing module 143 other than the broadcasting communication module 141. Furthermore, the audio reproducing module 142 or the video reproducing module 143 of the multimedia module 140 may be included in the controller 110.

The camera module 150 may include at least one of the first camera 151 and the second camera 152 for photographing a still image or a video under the control of the controller 110. The first camera 151 or the second camera 152 may include an auxiliary light source (e.g., a flash (not illustrated)) providing an amount of light for photography. The first camera 151 may be disposed on a front surface of the electronic device 100, and the second camera 152 may be disposed on a rear surface of the electronic device 100. According to another embodiment, the first camera 151 and the second camera 152 may be arranged adjacent to each other (e.g., a distance between the first camera 151 and the second camera 152 is larger than 1 cm and smaller than 8 cm) to photograph a 3D still image or a 3D moving image.

The GPS module 155 may receive radio waves from a plurality of GPS satellites (not illustrated) in Earth's orbit and calculate a location of the electronic device 100 using Time of Arrival from the GPS satellites to the electronic device 100.

The sensor module 170 may include at least one sensor for detecting a state of the electronic device 100. For example, the sensor module 170 may include a proximity sensor for detecting a user's proximity to the electronic device 100, an illumination sensor (not illustrated) for detecting an amount of light around the electronic device 100, a motion sensor (not illustrated) for detecting a motion of the electronic device 100 (e.g., rotation of the electronic device 100 and acceleration or vibration applied to the electronic device 100), a geo-magnetic sensor (not illustrated) for detecting a point of a compass using Earth's magnetic field, a gravity sensor for detecting a direction in which the gravity is applied, an altimeter for detecting an altitude by measuring an atmospheric pressure, and the like. At least one sensor may detect the state of the electronic device 100, and may generate a signal corresponding to the detection to transmit the generated signal to the controller 110. The sensors of the sensor module 170 may be added or omitted according to a capability of the electronic device 100.

The sensor module 170 according to the embodiment of the present disclosure may include the proximity sensor. The proximity sensor may sense a user's motion (e.g., a movement of the user's finger) within a predetermined range close to the screen 190. For example, if the screen 190 is implemented in the capacitive type, the sensor module 170 implemented with the proximity sensor may detect a user's motion by sensing a change in electrostatic capacity generated within a predetermined range from the screen 190 (e.g., within a height of 10 cm from the screen 190). The user's motion sensed in this way may also be included in the user input (the hovering input). The power supply unit 180 may supply electrical power to one or more batteries (not illustrated) disposed in the housing of the electronic device 100 under the control of the controller 110. The one or more batteries (not illustrated) supply power to the electronic device 100. Furthermore, the power supply unit 180 may supply the electronic device 100 with power input from an external power source (not illustrated) through a wired cable connected with the connector 165. In addition, the power supply unit 180 may also supply the electronic device 100 with power wirelessly input from an external power source through a wireless charging technology.

According to an embodiment, the electronic device 100 may be connected with an external device (not illustrated) using an external device connecting unit such as the sub-communication unit 130, the connector 165, and the earphone connecting jack 167.

The external device may include various devices attached to or detached from the electronic device 100 through a wire, such as earphones, an external speaker, a Universal Serial Bus (USB) memory, a charger, a cradle/dock, a Digital Multimedia Broadcasting (DMB) antenna, a mobile payment related device, a health care device (a blood sugar tester or the like), a game machine, a car navigation device, and the like. Furthermore, the external device may include a short range communication device, such as a Bluetooth communication device or a Near Field Communication (NFC) device, which can be wirelessly connected with the electronic device 100 through short range communication, a Wi-Fi Direct communication device, and a wireless Access Point (AP). Furthermore, the external device may include different devices, a mobile phone, a smart phone, a table PC, a desktop PC, and a server.

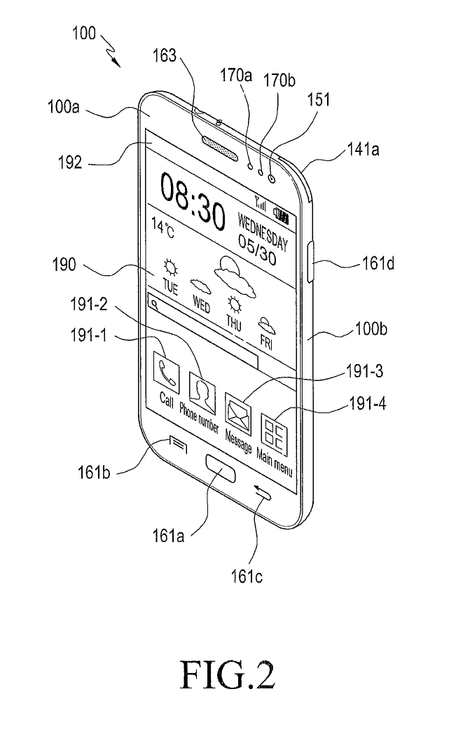

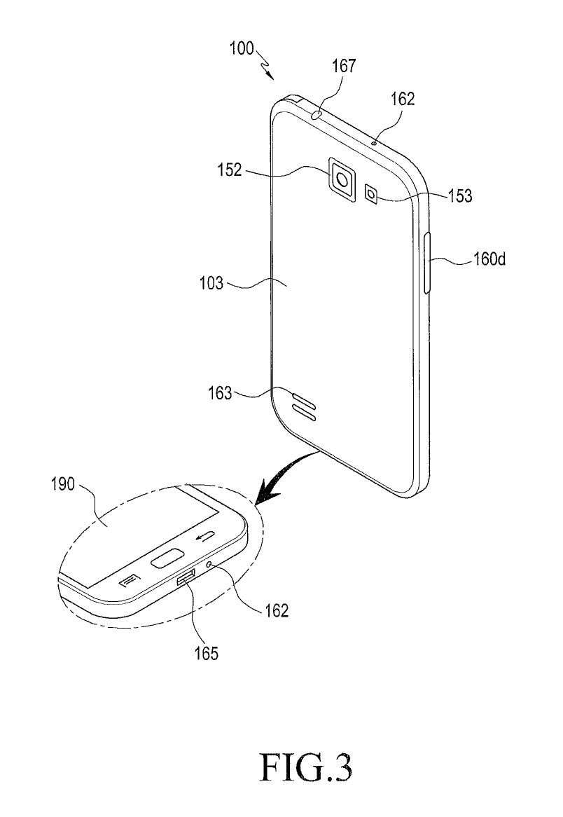

FIG. 2 is a front perspective view of an electronic device according to an embodiment of the present disclosure, and FIG. 3 is a rear perspective view of the electronic device according to the embodiment of the present disclosure.

Referring to FIG. 2, a screen 190 may be disposed in the center of a front surface 100a of an electronic device 100. The screen 190 may be formed to be large enough to occupy most of the front surface 100a of the electronic device 100.

FIG. 2 illustrates an example in which a main home screen is displayed on the screen 190. The main home screen is a first screen displayed on the screen 190 when the electronic device 100 is turned on. Furthermore, when the electronic device 100 has several pages of different home screens, the main home screen may be the first home screen among the several pages of different home screens. Shortcut icons 191-1, 191-2, and 191-3 for executing frequently used applications, a main menu switching key 191-4, time, weather, and the like may be displayed on the home screen. The main menu switching key 191-4 may display a menu screen on the screen 190. Furthermore, indicating a status of the mobile terminal 100 such as a battery charging status, intensity of a received signal, and current time, a status bar 192 may be formed on an upper side of the screen 190.

A home button 161a, a menu button 161b, and a back button 161c may be formed on a lower side of the screen 190. The home button 161a may display the main home screen on the screen 190. For example, when the home button 161a is touched while a home screen different from the main home screen or the menu screen is being displayed on the screen 190, the main home screen may be displayed on the screen 190. Furthermore, when the home button 161a is touched while applications are being executed on the screen 190, the main home screen illustrated in FIG. 2 may be displayed on the screen 190. Moreover, the home button 161a may also be used to allow recently used applications or a task manager to be displayed on the screen 190.

The menu button 161b may provide a connection menu which may be used on the screen 190. The connection menu may include a widget addition menu, a background changing menu, a search menu, an editing menu, an environment setting menu, and the like.

The back button 161c may display the screen executed just before the currently executed screen, or may terminate the most recently used application.

A first camera 151, an illumination sensor 170a, and a proximity sensor 170b may be disposed at an edge of the front surface 100a of the electronic device 100. A second camera 152, a flash 153, and a speaker 163 may be disposed on the rear surface 100c of the electronic device 100.

For example, a power/reset button 160a, a volume button 161b, a terrestrial DMB antenna 141a for reception of broadcasting, and one or more microphones 162 may be disposed on the side surface 100b of the electronic device 100. The DMB antenna 141a may be secured to the electronic device 100, or may be detachably coupled to the electronic device 100.

A connector 165 may be formed on a bottom side surface of the electronic device 100. A plurality of electrodes is formed in the connector 165, and the connector 165 may be connected with an external device in a wired manner. An earphone connecting jack 167 may be formed on a top side surface of the electronic device 100. Earphones may be inserted into the earphone connecting jack 167.

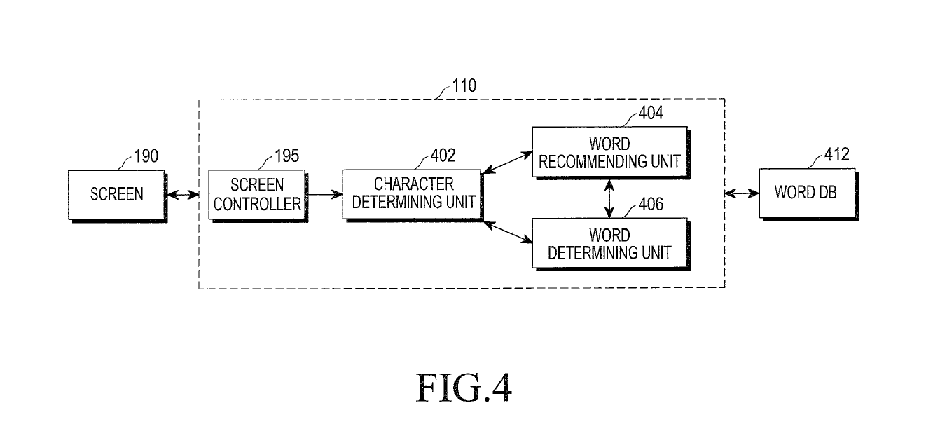

FIG. 4 is a block diagram illustrating a configuration of the controller included in the electronic device illustrated in FIG. 1. While a screen 190 and a word DB 412 included in a storage unit 175 are illustrated together in FIG. 4 for convenience of description, it is assumed that a screen controller 195 is implemented in the form included in the controller 110.

Referring to FIG. 4, the controller 110 may include at least one of a character determining unit 402, a word recommending unit 404, and a word determining unit 406.

When a user input for selecting a character, namely, a character input is entered through the screen 190, the screen controller 195 may determine a coordinate of a point where the character input has been entered as an input coordinate. When the input coordinate is determined, the screen controller 195 may transfer the input coordinate to the character determining unit 402.

The character determining unit 402 may determine a character corresponding to the character input based on the input coordinate. If the electronic device 100 receives an input of a character from a user through a virtual keypad displayed on the screen 190, each of character keys included in the virtual keypad has a corresponding coordinate. The character determining unit 402 may determine the character corresponding to the character input by determining a character key corresponding to the input coordinate.

According to an embodiment, the electronic device 100 may also receive an input of handwriting from a user, and the character determining unit 402 may also analyze the handwriting to determine a character most similar to the handwriting as a character input by the user.

The word recommending unit 404 may extract at least one recommended word from the word DB 412. For example, a word dictionary may have been stored in the word DB 412 implemented in the form included in the storage unit 175. The word recommending unit 404 may extract words similar to the word input by a user as recommended words from the word DB 412. The word recommending unit 404 may extract words including a temporary word as the recommended words from the word DB 412.

For example, it is assumed that a user inputs “rfe” while “pe” has already been input. If “rfe” is input in succession to “pe” without a blank field, this may imply that the user has input “pe” and “rfe” in succession so as to input a word. Accordingly, the word determining unit 406 may determine “perfe” as a temporary word. The word recommending unit 404 may extract words including “perfe” as recommended words from the word DB 412. The word recommending unit 404 may accordingly extract “perfect”, “perfection”, “perfectly”, and the like as the recommended words corresponding to the temporary word “perfe” from the word DB 412. When the recommended words are determined, the word recommending unit 404 may transfer the recommended words to the screen 190 and control the screen 190 to display the recommended words.

The word determining unit 406 may determine a word input by a user. According to an embodiment, when the character according to the user input is determined by the character determining unit 402, the word determining unit 406 may determine a temporary word. For example, if “a” is input as the character input according to the user input while “he” has already been input to the electronic device 100, the word determining unit 406 may determine “hea” as the temporary word.

It is assumed that a cursor is being displayed to be closest to a word or a character being currently input by a user on the screen 190. For example, if a user inputs “a” as the character input while a cursor is blinking on a right side of “he”, the word determining unit 406 may determine “hea” as the temporary word. As described above, the word determining unit 406 may determine the temporary word in view of the current location of the cursor.

Furthermore, the word recommending unit 404 may determine recommended words based on the temporary word. For example, the word recommending unit 404 may extract “head”, “health”, “hear”, “heart”, and the like as recommended words corresponding to the temporary word “hea” from the word DB 412. According to an embodiment, the word determining unit 406 may determine whether a user input is entered for selecting any one of the recommended words displayed on the screen 190. When the user input is entered for selecting any one of the recommended words, the word determining unit 406 may control the screen 190 to change the temporary word to the corresponding recommended word and to display the recommended word. For example, it is assumed that “hea” is displayed as a temporary word and “head”, “health”, “hear” and “heart” are displayed as recommended words for “hea”. If a user enters a user input for selecting “hear” among the recommended words, the word determining unit 406 may control the electronic device 100 to change the temporary word “hea” to “hear” and to display “hear”.

According to an embodiment, if the user input for selecting any one of the recommended words is not input, the word determining unit 406 may control the electronic device 100 to maintain the temporary word displayed. For example, it is assumed that “head”, “health”, “hear” and “heart” are displayed as recommended words for “hea”, and a user does not select any of the recommended words. The word determining unit 406 may control the electronic device 100 to continuously display the temporary word “hea” on the screen 190.

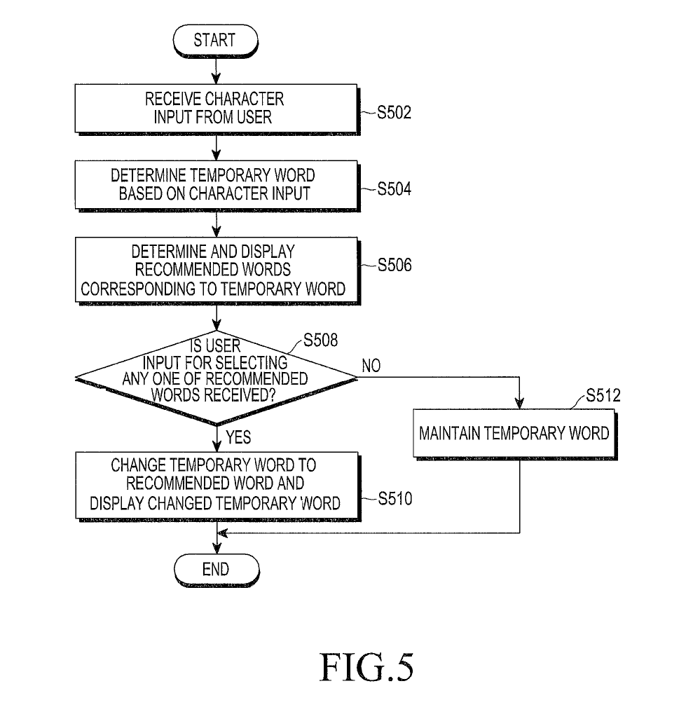

FIG. 5 is a flowchart illustrating an example of a method in which the electronic device illustrated in FIG. 1 modifies a text input from a user.

Referring to FIG. 5, the electronic device 100 may receive a character input from a user (operation S502). According to an embodiment, the user may input the character through a virtual keypad displayed on the screen 190 in operation 502. The screen controller 195 may determine an input coordinate of the character input entered through the screen 190. The character determining unit 402 may determine the character input entered by the user in operation S502, by determining a character key corresponding to the input coordinate among character keys included in the virtual keypad.

The character determining unit 402 of the controller 110 may determine a word which has been input up to now, based on the character input (operation S504). For example, assuming that “o” and “p” have been input to the electronic device 100 before operation S502 and “e” is input by a user in operation S502, the character determining unit 402 may determine the characters “ope”, which has been input up to now, as a temporary word in operation S504.

Thereafter, the word recommending unit 404 may determine recommended words corresponding to the temporary word and display the recommended words through the screen 190 (operation S506). In operation S506, the word recommending unit 404 may search the word DB 412 to extract recommended words similar to the temporary word from the word DB 412. For example, the word recommending unit 404 may extract “open”, “operate”, “operation”, and the like as recommended words corresponding to the temporary word “ope”.

The word determining unit 406 of the controller 110 may determine whether a user input has been received for selecting any one of the recommended words (S508). According to an embodiment, when a first special key of the virtual keypad displayed on the screen 190 is input, the word determining unit 406 may determine that the user input has not been input for selecting any one of the recommended words. Furthermore, when a second special key is input, the word determining unit 406 may determine that the user input has been input for selecting any one of the recommended words.

When it is determined in operation S508 that the user input has been received for selecting any one of the recommended words (S508-Yes), the word determining unit 406 may change the temporary word to the recommended word selected by the user to display the recommended word (S510). For example, if the user selects “open” among the recommended words “open”, “operate”, and “operation” corresponding to “ope”, the word determining unit 406 may control the screen 190 to change “ope” to “open” and to display “open”.

When it is determined in operation S508 that the user input has not been received for selecting any one of the recommended words (S508-No), the controller 110 may maintain the temporary word (operation S512). For example, if the user does not select any of the recommended words “open”, “operate”, and “operation” corresponding to “ope”, the word determining unit 406 may control the screen 190 to maintain “ope”.

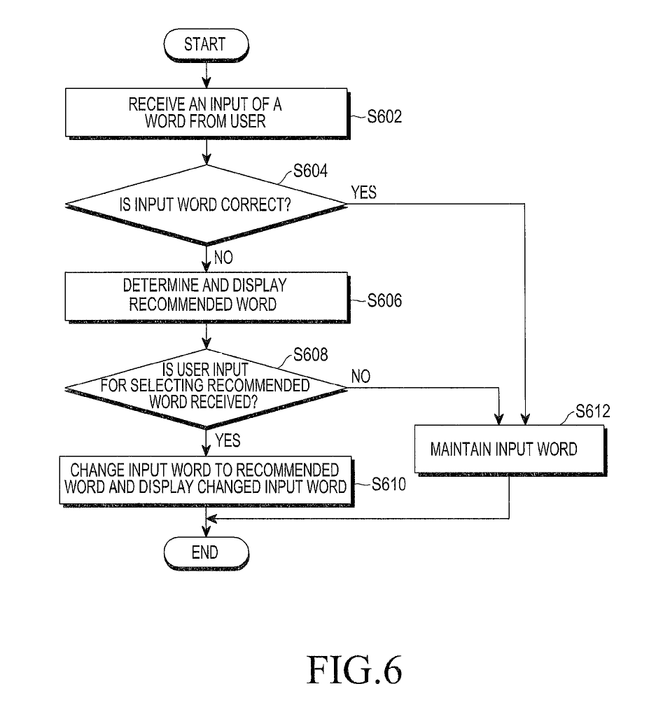

FIG. 6 is a flowchart illustrating another example of a method in which the electronic device illustrated in FIG. 1 modifies a text input from a user.

Referring to FIG. 6, the electronic device 100 receives an input of a word from a user (operation S602). According to an embodiment, the user may input the word through a virtual keypad displayed on the screen 190 in operation S602.

The controller 110 may determine whether the input word is a correct word (operation S604). When it is determined in operation S604 that the input word is a correct word (S604-Yes), the controller 110 may maintain the input word (operation S612).

When it is determined in operation S604 that the input word is not a correct word (S604-No), the controller 110 may determine and display a recommended word corresponding to the input word (operation S606). According to an embodiment, the controller 110 may search a database of the storage unit 175 to discover words similar to the input word. Furthermore, the controller 110 may determine the word having the highest similarity among the words similar to the input word as a recommended word.

Thereafter, the controller 110 may determine whether a user input has been received for selecting the recommended word (operation S608). According to an embodiment, when a first special key of the virtual keypad displayed on the screen 190 is input, the controller 110 may determine that the user input has not been entered for selecting the recommended word. Furthermore, when a second special key is input, the controller 110 may determine that the user input has been entered for selecting the recommended word. That is, in the embodiment of the present disclosure, the user may select the first special key or the second special key to determine whether the word recommended by the electronic device 100 is to be substituted for the text or word input by the user. The electronic device 100 according to the embodiment of the present disclosure may maintain the word input in operation S602 or amend the input word to a correct word according to whether the user input corresponds to the first special key or the second special key.

When it is determined in operation S608 that the user input has been received for selecting the recommended word (S608-Yes), the controller 110 may change the input word to the recommended word to display the recommended word (operation S610).

When it is determined in operation S608 that the user input has not been received for selecting the recommended word (S608-No), the controller 110 may maintain the input word (operation S612).

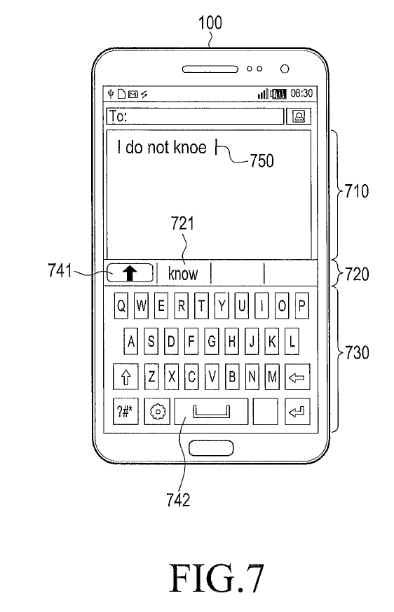

FIG. 7 illustrates an example in which the electronic device illustrated in FIG. 1 modifies a text input from a user. In the embodiment of the present disclosure, it is assumed that the electronic device 100 receives an input of a word from the user through the virtual keypad displayed on the screen 190.

The electronic device 100 may display an input area 710, a word area 720, and a keypad area 730 to receive an input of words from the user through the screen 190. The words input from the user may be displayed in the input area 710, and a recommended word for a currently input word or a word closest to a cursor 750 may be displayed in the word area 720. The currently input text or word, or the text or word closest to the cursor 750 is referred to as ‘temporary text’.

The keypad 730 including first and second special keys 741 and 742 may be displayed in the keypad area 730. The user may input a desired character or special character to the electronic device 100 by selecting and pushing any one of keys included in the keypad area 730.

Referring to FIG. 7, the electronic device 100 receives an input of a. text “I do not knoe” from the user. The controller 110 may differentiate the words through word spacing. The text “I do not knoe” illustrated in FIG. 7 is configured with words “I”, “do”, “not” and “knoe”. The word “knoe” on the left side of the cursor 750 corresponds to a temporary text.

In the embodiment of the present disclosure, the controller 110 may determine whether the word closest to the cursor 750, namely, the temporary text is a correct word. In FIG. 7, the word closest to the cursor 750, namely, the temporary text is “knoe”. The controller 110 may accordingly determine whether “knoe” is a correct word. In FIG. 7, it is assumed that “knoe” has been mistakenly input instead of “know”.

Since “knoe” has been mistakenly input as described above, the controller 110 may extract the word having the highest similarity to the input word as a recommended word from the storage unit 175. In the embodiment of the present disclosure, “know” 721 is assumed to have the highest similarity to “knoe”. The controller 110 may extract “know” 721 as a recommended word for “knoe” from the storage unit 175. The controller 110 may display “know” 721 in the word area 720. The word area 720 may be an area where one or more recommended words are displayed.

According to an embodiment, the controller 110 of the electronic device 100 may receive a user input for selecting a first key (e.g., a second special key 742) or a second key (e.g., a first special key 741). According to the embodiment, when the user input for selecting the first key (e.g., the second key 742) is entered, the controller 110 may control the electronic device 100 to maintain the currently displayed text on the screen 190, namely, the temporary word. In FIG. 7, “knoe” on the left side of the cursor 750 is the text input by the user and corresponds to a temporary word. While the temporary word is being displayed as described above, the electronic device 100 may display one or more recommended words, which may replace the temporary word, on the screen 190. In FIG. 7, “know” 721 is displayed as one recommended word. The first key (e.g., the second special key 742) may be a user input for maintaining the temporary word. Accordingly, when the user enters a user input for selecting the second special key 742 to the electronic device 100, the electronic device 100 may maintain “knoe” on the left side of the cursor 750 without changing it to another word.

The second key may be a user input for changing the temporary word to any one of recommended words. Accordingly, when a user input for selecting the second key (e.g., the first special key 741) is entered, the controller 110 may change the temporary word displayed on the screen 190 to the recommended word having the highest similarity to the temporary word among one or more recommended words displayed on the screen 190. In FIG. 7, when the user enters the user input for selecting the first special key 741 to the electronic device 100, the electronic device 100 may change “knoe” on the left side of the cursor 750 to “know” 721 and display “know” 721.

Although one recommended word “know” 721 is provided in FIG. 7, a plurality of recommended words may be provided, and when the user input for selecting the second key (e.g., the first special key 741) is entered, the controller 110 may change the temporary word to the recommended word having the highest similarity to the temporary word among the recommended words. According to an embodiment, the recommended words may be displayed to be close to the second key in a descending order of similarity to the temporary word.

Although, in FIG. 7, the first key (e.g., the second special key 742) and the second key (e.g., the first special key 741) are implemented as a form of being included in the keypad area 730 and the word area 720, respectively, the first key and the second key may also be displayed to be close to the temporary word and the recommended word, respectively, according to another embodiment.

Furthermore, while both the first key (e.g., the second special key 742) and the second key (e.g., the first special key 741) are displayed in FIG. 7, only the first key or the second key may also be displayed according to another embodiment. When only one key is displayed, if the first key or the second key is selected by the user, the controller 110 may change the temporary word to the recommended word having the highest similarity to the temporary word.

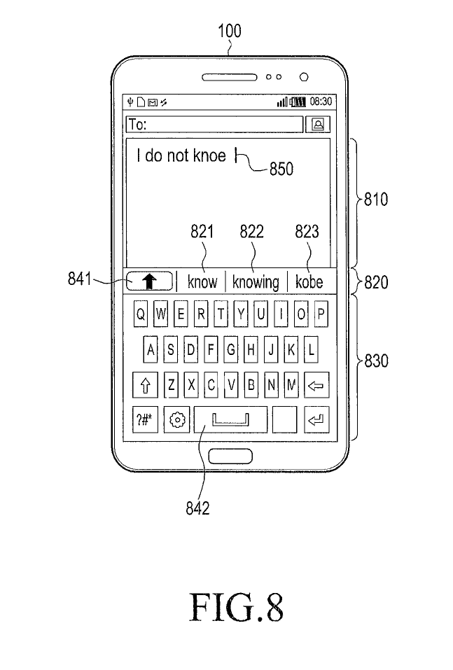

FIG. 8 illustrates another example in which the electronic device illustrated in FIG. 1 modifies a text input from a user. In the embodiment of the present disclosure, it is assumed that the electronic device 100 receives an input of a word from a user through the virtual keypad displayed on the screen 190.

The electronic device 100 may display an input area 810, a word area 820, and a keypad area 830 to receive an input of words from the user through the screen 190. The words input from the user may be displayed in the input area 810, and recommended words for a currently input word or a word closest to a cursor 850 may be displayed in the word area 820. Furthermore, a virtual keypad including a first special key 841 and a second special key 842 may be displayed in the keypad area 730. The user may input a desired character or special character to the electronic device 100 by selecting and pushing any one of keys included in the virtual keypad of the keypad area 830.

Referring to FIG. 8, the electronic device 100 receives an input of a text “I do not knoe” from the user. The controller 110 may differentiate the words through word spacing. Further, the controller 110 may determine the word closest to the cursor 850 as a word being currently input by the user, namely, a temporary word. In addition, the controller 110 may determine whether the temporary word is a correct word. In FIG. 8, the word closest to the cursor 850 is “knoe”. The controller 110 may accordingly determine “knoe” as the temporary word, and judge whether the temporary word “knoe” is a correct word. Similar to FIG. 7, it is assumed that “knoe” has been mistakenly input instead of “know”.

Since “knoe” has been mistakenly input as described above, the word recommending unit 404 of the controller 110 may extract recommended words 821, 822 and 823 corresponding to the temporary word “knoe” from the word DB 412 of the storage unit 175. In the embodiment of the present disclosure, the word recommending unit 404 extracts “know” 821, “knowing” 822 and “kobe” 823 as the recommended words corresponding to “knoe” from the word DB 412. Furthermore, it is assumed that the controller 110 arranges and displays the recommended words 821, 822 and 823 in a descending order of similarity. In the embodiment of the present disclosure, if a user input for selecting the second special key 842 is entered, the controller 110 may determine that among the recommended words, the word having the highest similarity to the temporary word has been selected. When the second special key 842 is pushed while “know” 821, “knowing” 822 and “kobe” 823 are displayed as the recommended words, the word determining unit 406 may determine that “know” 821 is to be substituted for “knoe”. In contrast, when the first special key 841 is pushed, the word determining unit 406 may control the electronic device 100 to maintain “knoe”

Although the electronic device 100 receives the input of the text or word through the virtual keypad included in the keypad area 830 in the embodiment of the present disclosure, according to other embodiments, the electronic device 100 may also receive an input of handwriting through a user's hand or a stylus pen and an input of a text or word through the keypad 166 included in the input/output module 160.

Furthermore, although the first special key 841 is illustrated as a key displayed on a left side of the word area 820, and the second special key 842 is illustrated as a space bar at a lower center of the virtual keypad in the embodiment of the present disclosure, the first and second special keys 841 and 842 may also correspond to other keys according to another embodiment. Furthermore, according to an embodiment, the electronic device 100 may also configure the first special key or the second special key according to a user input.

According to an embodiment, the controller 110 of the electronic device 100 may receive a user input for selecting a first key (e.g., the second special key 842) or a second key (e.g., the first special key 841). According to the embodiment, when the user input for selecting the first key (e.g., the second key 842) is entered, the controller 110 may control the electronic device 100 to maintain the currently displayed text on the screen 190, namely, the temporary word. In FIG. 8, ‘knoe’ on the left side of the cursor 850 is a text input by the user and corresponds to a temporary word. While the temporary word is being displayed as described above, the electronic device 100 may display one or more recommended words, which may replace the temporary word, on the screen 190. In FIG. 8, “know” 821, “knowing” 822, and “kobe” 823 are displayed as the recommended words. The first key (e.g., the second special key 842) may be a user input for maintaining the temporary word. Accordingly, when the user enters the user input for selecting the second special key 842 to the electronic device 100, the electronic device 100 may maintain “knoe” on the left side of the cursor 850 without changing it to another word.

The second key may be a user input for changing the temporary word to any one of the recommended words 821, 822, and 823. Accordingly, when the user input for selecting the second key (e.g., the first special key 841) is entered, the controller 110 may change the temporary word displayed on the screen 190 to the recommended word having the highest similarity to the temporary word among one or more recommended words displayed on the screen 190. In FIG. 8, when the user enters the user input for selecting the first special key 841 to the electronic device 100, the electronic device 100 may change “knoe” on the left side of the cursor 850 to any one of “know” 821, “knowing” 822, and “kobe” 823 and display it.

According to an embodiment, the recommended words may be displayed to be close to the second key in a descending order of similarity to the temporary word. In FIG. 8, when the user input for selecting the second key (e.g., the first special key 841) is entered, the controller 110 may change “knoe” to “know” 821 closest to the first special key 841.

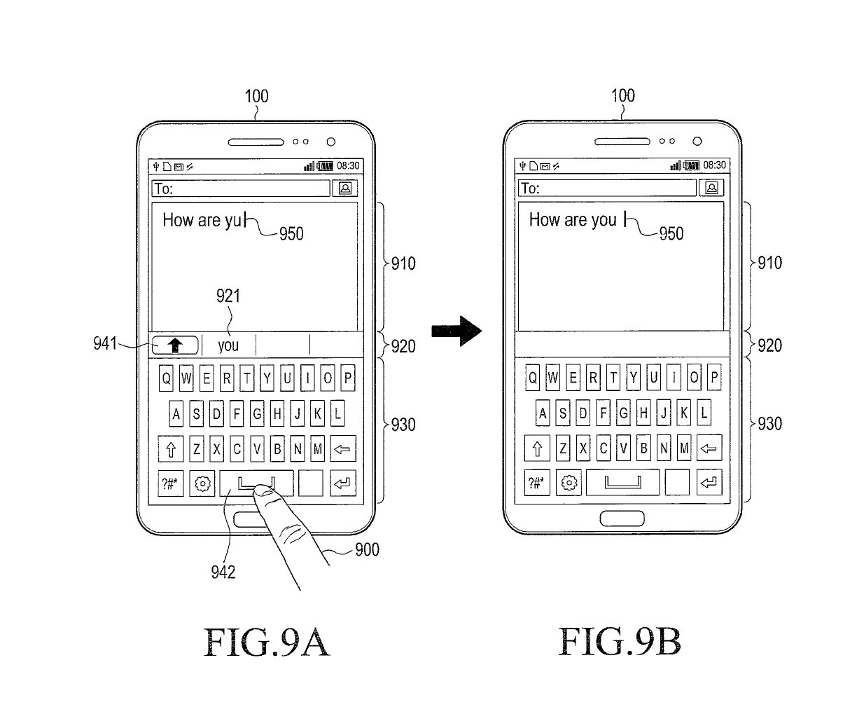

FIGS. 9A and 9B illustrate another example in which the electronic device illustrated in FIG. 1 modifies a text input from a user. In the embodiment of the present disclosure, it is assumed that the electronic device 100 receives an input of a word from a user through the virtual keypad displayed on the screen 190.

The electronic device 100 may display an input area 910, a word area 920, and a keypad area 930 to receive an input of words from the user through the screen 190. The words input from the user may be displayed in the input area 910, and at least one recommended word corresponding to a currently input word or a word closest to a cursor 950, namely, a temporary word may be displayed in the word area 920. Furthermore, a virtual keypad including a first special key 941 and a second special key 942 may be displayed in the keypad area 730. The user may input a desired character or special character to the electronic device 100 by selecting and pushing any one of keys included in the keypad area 930.

Referring to FIG. 9A, the electronic device 100 receives an input of a text “How are yu” from the user. The controller 110 may differentiate the words through word spacing. In FIG. 9A, “How are yu” is a text configured with words “how”, “are”, and “yu”. In the embodiment of the present disclosure, the controller 110 may determine whether the word closest to the cursor 950, namely, the temporary word is a correct word. In FIG. 9A, the word closest to the cursor 950 is “yu”. Accordingly, the word determining unit 406 of the controller 110 may determine “yu” as the temporary word, and judge whether the temporary word “yu” is a correct word. In FIG. 9A, it is assumed that “yu” has been mistakenly input instead of “you”.

Since “yu” has been mistakenly input as described above, the controller 110 may extract the word having the highest similarity to the input word as a recommended word from the word DB 412 of the storage unit 175. In the embodiment of the present disclosure, “you” is assumed to have the highest similarity to “yu”. The controller 110 may extract “you” as the recommended word for “yu” from the word DB 412 of the storage unit 175. The controller 110 may display “you” 921 in the word area 920.

In FIG. 9A, a user 900 enters the user input for selecting the second special key 942 to the electronic device 100. The second special key 942 is a key for changing the temporary word to the recommended word. Furthermore, in the embodiment of the present disclosure, it is assumed that when the second special key 942 is input, the electronic device changes the temporary word to the recommended word to display the recommended word, and leaves a space after the recommended word at the same time. The electronic device 100 after the input of the second special key 942 is illustrated in FIG. 9B. The temporary word “yu” is changed to “you”, and “How are you” is displayed in the input area 910 of the electronic device 100.

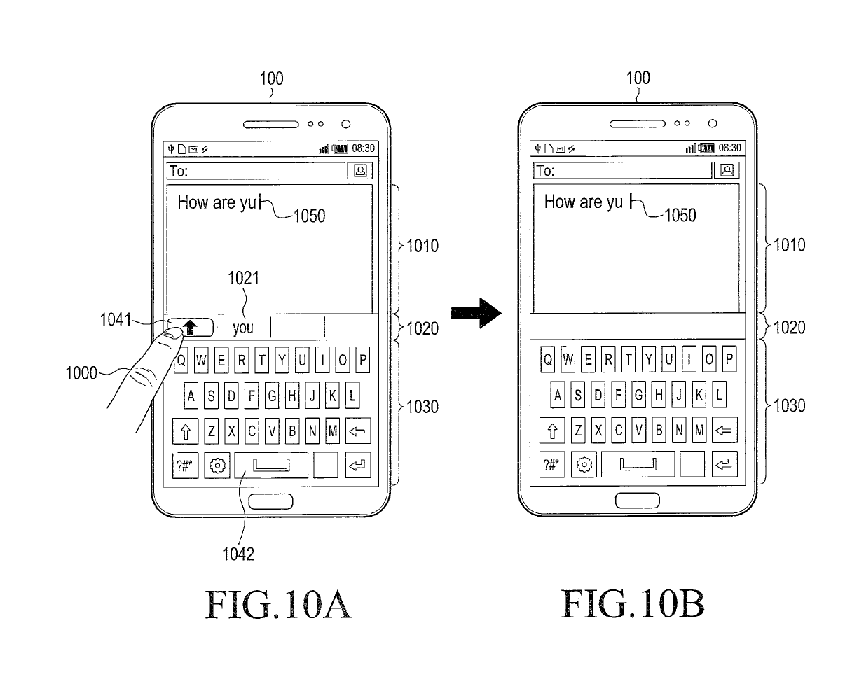

FIGS. 10A and 10B illustrate another example in which the electronic device illustrated in FIG. 1 modifies a text input from a user. In the embodiment of the present disclosure, it is assumed that the electronic device 100 receives an input of a word from a user through the virtual keypad displayed on the screen 190.

The electronic device 100 may display an input area 1010, a word area 1020, and a keypad area 1030 to receive an input of words from the user through the screen 190. The words input from the user may be displayed in the input area 1010, and a recommended word for a currently input word or a word closest to a cursor 1050, namely, a temporary word may be displayed in the word area 1020. Furthermore, a virtual keypad including a first special key 1041 and a second special key 1042 may be displayed in the keypad area 730. The user may input a desired character or special character to the electronic device 100 by selecting and pushing any one of keys included in the keypad area 1030.

Referring to FIG. 10A, the electronic device 100 receives an input of a text “How are yu” from the user. The controller 110 may differentiate the words through word spacing. In FIG. 10A, “How are yu” is a text configured with words “how”, “are”, and “yu”. In the embodiment of the present disclosure, the controller 110 may determine whether the word closest to the cursor 1050, namely, the temporary word is a correct word. In FIG. 10A, the word closest to the cursor 1050 is “yu”. Accordingly, the word determining unit 406 of the controller 110 may determine “yu” as the temporary word, and judge whether the temporary word “yu” is a correct word. Similar to FIG. 9A, it is assumed that “yu” has been mistakenly input instead of “you”.

Since “yu” has been mistakenly input as described above, the controller 110 may extract the word having the highest similarity to the input word as a recommended word from the word DB 412 of the storage unit 175. In the embodiment of the present disclosure, “you” is assumed to have the highest similarity to “yu”. The controller 110 may extract “you” as the recommended word for “yu” from the word DB 412 of the storage unit 175. The controller 110 may display “you” 1021 in the word area 1020.

In FIG. 10A, a user 1000 enters the user input for selecting the first special key 1041 to the electronic device 100. The first special key 1041 is a key for maintaining the temporary word without changing the temporary word to the recommended word. Furthermore, in the embodiment of the present disclosure, it is assumed that when the first special key 1041 is input, the electronic device maintains the temporary word and leaves a space after the temporary word at the same time. The electronic device 100 after the input of the first special key 1041 is illustrated in FIG. 10B. Since the temporary word “yu” is not changed to “you”, “How are yu” is displayed in the input area 1010.

In the embodiment of the present disclosure, the temporary word is maintained, and at the same time, the space is left after the temporary word when the first special key 1041 is input. However, according to another embodiment, when the first special key 1041 is input, a space may not be left after the temporary word. According to an embodiment, when a text input is not entered from the user for a reference period of time stored in advance in the storage unit 175 after the input of the first special key 1041, the controller 110 may control the electronic device to leave a space after the temporary word. Furthermore, according to an embodiment, after the input of the first special key 1041, the controller 110 may also receive a user input for leaving a space after the temporary word from the user through the screen 190. For example, the user may push a space bar on the virtual keypad to leave the space after the temporary word.

Furthermore, according to an embodiment, after the first special key 1041 is input and then it is determined that the temporary word is to be maintained, the controller 110 may determine whether a character or word after the temporary word is input to the electronic device 100. For example, the user may input the first special key 1041 for maintaining the temporary word “yu” to the electronic device 100, and thereafter, may input a word “and” subsequent to the temporary word “yu” to the electronic device 100. When “and” or “a” is input from the user after the first special key 1041 for maintaining the temporary word “yu” is input, the controller 110 may control the electronic device 100 to leave a space between “yu” and “and”. Even though a user input for leaving the space between “yu” and “and” is not entered into the electronic device 100, the controller 110 may control the electronic device 100 to automatically leave the space between “yu” and “and”.

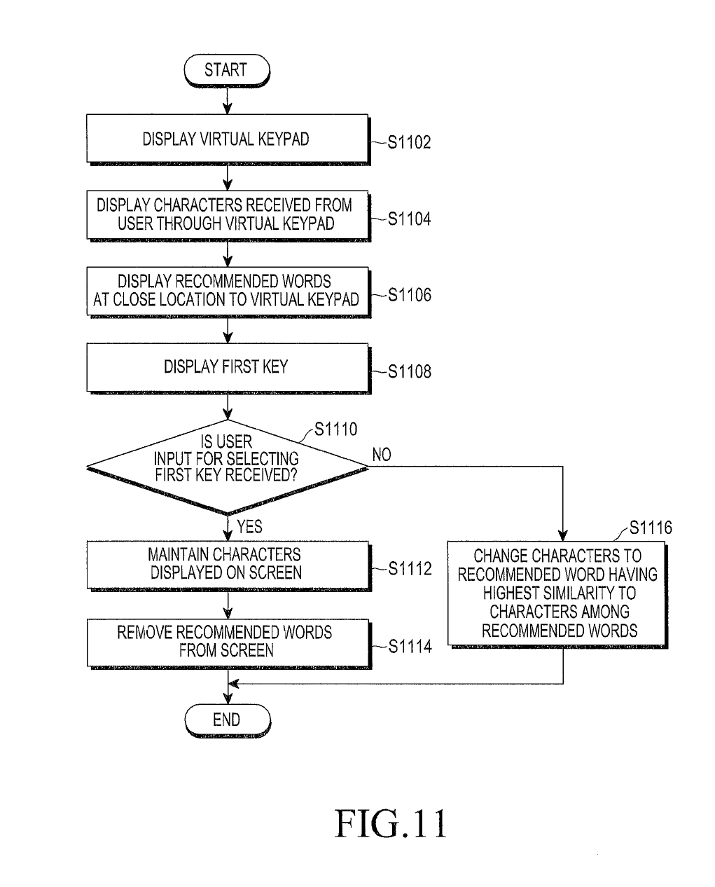

FIG. 11 is a flowchart illustrating a method of operating an electronic device according to an embodiment of the present disclosure.

Referring to FIG. 11, a screen 190 may display a virtual keypad (operation S1102). The screen 190 may display one or more characters received from a user through the virtual keypad (operation S1104). Furthermore, the screen 190 may display recommended words at a close location to the virtual keypad under the control of a controller 110 (operation S1106). The screen 190 may display a first key (operation S1108). The controller 110 may determine whether a user input has been received for selecting the first key (operation S1110).

When it is determined in operation S1110 that the user input for selecting the first key has been received (S1110-Yes), the controller 110 may control an electronic device 100 to maintain the characters displayed on the screen 190 (operation S1112). According to an embodiment, the controller 110 may remove the recommended words from the screen 190 (operation S1114).

When it is determined in operation S1110 that the user input for selecting the first key has not been received (S1110-No), for example, when a user input for selecting another key (e.g., a second key) displayed on the screen 190 has been received, the controller 110 may change the currently displayed characters on the screen 190 to the word having the highest similarity to the characters among the recommended words (operation S1116).

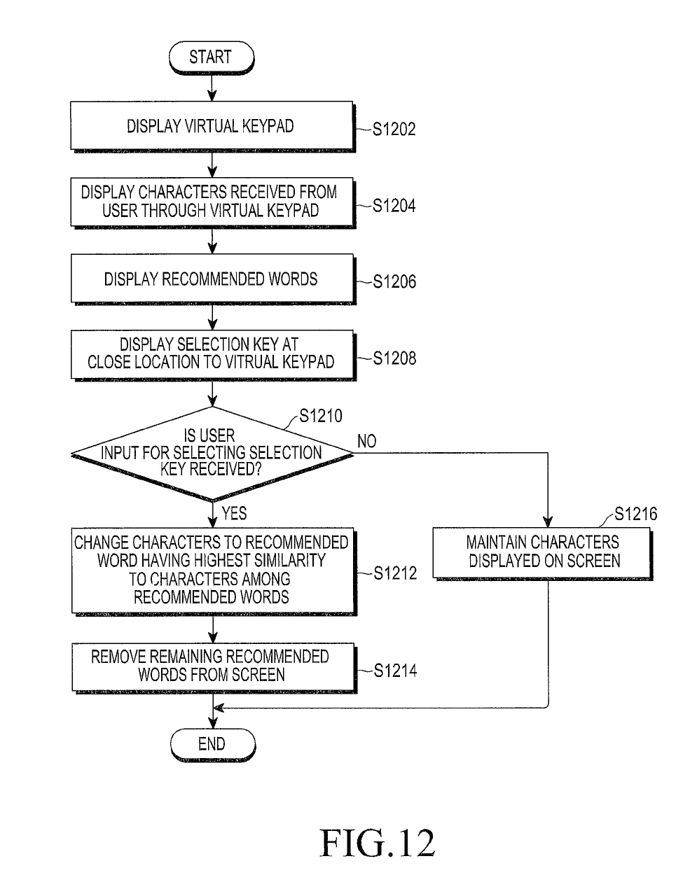

FIG. 12 is a flowchart illustrating a method of operating an electronic device according to another embodiment of the present disclosure.

Referring to FIG. 12, a screen 190 may display a virtual keypad (operation S1202). The screen 190 may display one or more characters received from a user through the virtual keypad (operation S1204). Furthermore, the screen 190 may display recommended words at a close location to the virtual keypad under the control of a controller 110 (S1206). The screen 190 may display a selection key (operation S1208). The controller 110 may determine whether a user input has been received for selecting the selection key (operation S1210).

When it is determined in operation 1210 that the user input has been received for selecting the selection key (S1210-Yes), the controller 110 may change the currently displayed characters on the screen to the recommended word having the highest similarity to the characters among the recommended words displayed in operation S1206 (operation S1212). According to an embodiment, the controller 110 may remove, from the screen 190, the remaining recommended words other than the characters changed in operation S1212, namely, the recommended word selected by the user through the input of the selection key to the electronic device 100 (operation S1214).

When it is determined in operation 1210 that the user input has been not received for selecting the selection key (S1210-No), the controller 110 may control the electronic device 100 to maintain the characters displayed on the screen 190 (operation S1216).

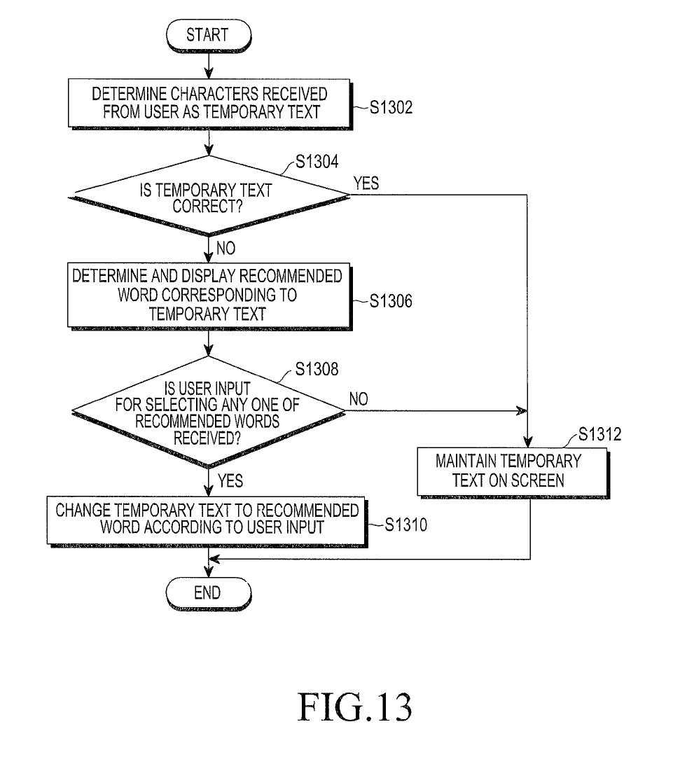

FIG. 13 is a flowchart illustrating a method of operating an electronic device according to another embodiment of the present disclosure.

Referring to FIG. 13, a controller 110 may determine, for example, characters received from a user through a screen 190 as a temporary text (operation S1302). Furthermore, in operation S1302, the screen 190 may display the characters received from the user, namely, the temporary text in real time.

The controller 110 may determine whether the temporary text is correct (operation S1304). When it is determined in operation S1304 that the temporary text is correct (S1304-Yes), the controller 110 may maintain the temporary text on the screen 190 (operation S1312). That is, the screen 190 may continuously display the temporary text.

When it is determined in operation S1304 that the temporary text is not correct (S1304-No), the controller 110 may determine one or more recommended words corresponding to the temporary text and display them through the screen 190 (operation S1306).

Thereafter, the controller 110 may determine whether a user input has been received for selecting any one of the recommended words (operation S1308). When it is determined in operation S1308 that the user input has been received for selecting any one of the recommended words (S1308-Yes), the controller 110 may change the temporary text to the recommended word depending on the user input (S1310), Furthermore, in operation S1310, the screen 190 may display the recommended word.

When it is determined in operation S1308 that the user input has not been received for selecting any one of the recommended words (S1308-No), the controller 110 may maintain the temporary text on the screen 190 (operation S1312) According to an embodiment, when a user input for selecting a first key, a second key, or a selection key is not entered as the user input for selecting any one of the recommended words, the controller 110 may determine that the user input has not been received for selecting any one of the recommended words.

As described above, the present disclosure provides the method of modifying the text input from the user and the electronic device therefor.

Furthermore, it can be seen that the method of modifying the text input by the user according to the embodiment of the present disclosure can be implemented in the form of hardware, software or a combination thereof. Such an arbitrary software may be stored in, for example, irrespective of being erasable or rewritable, a volatile or non-volatile storage device such as a ROM, a memory such as a RAM, a memory chip device, or an integrated circuit, an optically or magnetically recordable and machine (e.g., a computer) readable storage medium such as a CD, a DVD, a magnetic disk, or a magnetic tape. The method of modifying the text input by the user according to the embodiments of the present disclosure may be implemented by a computer or a mobile terminal including a controller and a memory, and it can be seen that the memory is an example of the machine readable storage medium which is suitable for storing a program or programs including instructions by which the embodiments of the present disclosure are realized. Accordingly, the present disclosure may include a program including a code for implementing a device and a method described in an arbitrary claim of the present specification, and a machine (computer, etc.) readable storage medium storing such a program. Furthermore, such a program may be electronically transferred through an arbitrary medium such as a communication signal transferred through a wired or wireless connection, and the present disclosure may appropriately include equivalents thereof.

In addition, the electronic device may receive the program from a program providing device connected thereto in a wired or wireless manner and store the received program. The program providing device may include a program including instructions allowing the electronic device to perform the method of modifying the text input by the user, a memory that stores information associated with the method of modifying the text input by the user, a communication unit that performs wired or wireless communication with the electronic device, and a controller that transmits the corresponding program to the electronic device in response to a request of the electronic device or automatically.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for operating an electronic device with a display, the method comprising:
displaying a virtual keypad on a screen of the display;
receiving one or more characters from a user through the virtual keypad;
displaying the one or more characters on the screen;
displaying one or more recommended words at a close location to the virtual keypad on the screen based on at least some of the one or more characters;
displaying a first key on the screen;
maintaining the one or more characters on the screen when a user input for selecting the first key is received; and
removing the recommended words from the screen.

2. The method of claim 1, wherein displaying the first key on the screen comprises:
displaying the first key at a location close to the one or more recommended words.

3. The method of claim 1, wherein displaying the first key on the screen comprises:
displaying the first key at a location close to the virtual keypad.

4. The method of claim 1, further comprising:
changing the one or more characters to a recommended word having a highest similarity to the one or more characters among the recommended words when a user input for selecting a second key different from the first key is received.

5. A method for operating an electronic device with a display, the method comprising:
displaying a virtual keypad on a screen of the display;
receiving one or more characters from a user through the virtual keypad;
displaying the one or more characters on the screen;
displaying one or more recommended words on the screen based on at least some of the one or more characters;
displaying a selection key on the screen; and
changing the one or more characters to a recommended word having a highest similarity to the one or more characters among the recommended words when a user input for selecting the selection key is received.

6. The method of claim 5, wherein the selection key is displayed to be close to the virtual keypad.

7. The method of claim 5, wherein the selection key is one of a space bar, a period key, and a comma key, and is contained in the virtual keypad.

8. The method of claim 5, further comprising:
removing the remaining recommended words other than the changed recommended word from the screen.

9. The method of claim 5, further comprising:
maintaining the one or more characters on the screen when the user input for selecting the selection is not received.

10. The method of claim 5, further comprising:
determining that a user input for selecting one of the recommended words has not been received, when a user input for selecting a first key different from the selection key is received.

11. A method for operating an electronic device with a display, the method comprising:
receiving one or more characters from a user;
determining the characters as a temporary text;
determining whether the temporary text is correct;
determining and displaying recommended words corresponding to the temporary text when the temporary text is not correct;
determining whether a user input for selecting one of the recommended words has been received; and
changing the temporary text to a recommended word depending on the user input and displaying the recommended word, when the user input for selecting one of the recommended words has been received.

12. The method of claim 11, further comprising:
maintaining and displaying the temporary text on the screen when the temporary text is a correct word.

13. The method of claim 11, further comprising:
maintaining the temporary text on the screen when the user input for selecting one of the recommended words has not been received.

14. The method of claim 11, further comprising:
determining that the user input for selecting the recommended word has not been received, when a user input for selecting a first key is received from the user.

15. The method of claim 11, further comprising:
changing the temporary text to a recommended word having a highest similarity to the temporary text among the recommended words when a user input for selecting a selection key is entered from the user.

16. An electronic device with a display, comprising:
a screen configured to:
display a virtual keypad; and
receive one or more characters from a user through the virtual keypad; and
a controller configured to:
control the screen to display the one or more characters on the screen;
control the screen to display one or more recommended words at a location close to the virtual keypad based on at least some of the one or more characters;
control the screen to display a first key;
control the screen to maintain the one or more characters when a user input for selecting the first key is received; and
remove the recommended words from the screen.

17. The electronic device of claim 16, wherein the controller is configured to control the screen to display the first key at a location close to the one or more recommended words.

18. The electronic device of claim 16, wherein the controller is configured to control he screen to display the first key at a location close to the virtual keypad.

19. The electronic device of claim 16, wherein the controller is configured to control the screen to change the one or more characters to a recommended word having a highest similarity to the one or more characters among the recommended words when a user input for selecting a second key different from the first key is received.

20. An electronic device with a display, comprising:
a screen configured to:
display a virtual keypad; and
receive one or more characters from a user through the virtual keypad; and
a controller configured to:
control the screen to display the one or more characters;
control the screen to display one or more recommended words based on at least some of the one or more characters;
control the screen to display a selection key; and
change the one or more characters to a recommended word having a highest similarity to the one or more characters among the recommended words when a user input for selecting the selection key is received.

21. The electronic device of claim 20, wherein the selection key is displayed to be close to the virtual keypad.

22. The electronic device of claim 20, wherein the selection key is one of a space bar, a period key, and a comma key, and is contained in the virtual keypad.

23. The electronic device of claim 20, wherein the controller is configured to remove the remaining recommended words other than the changed recommended word from the screen.

24. The electronic device of claim 20, wherein the controller is configured to control the screen to maintain the one or more characters on the screen when the user input for selecting the selection is not received.

25. The electronic device of claim 20, wherein the controller is configured to determine that a user input for selecting one of the recommended words has not been received, when a user input for selecting a first key different from the selection key is received.

26. An electronic device with a display, comprising:
a keypad configured to receives one or more characters from a user;
a screen configured to display the one or more characters; and
a controller configured to:
control the screen to determine the one or more characters as a temporary text;
determine whether the temporary text is correct;
determine recommended words corresponding to the temporary text when the temporary text is not correct;
control the screen to display the recommended words;
determine whether a user input for selecting one of the recommended words has been received;
change the temporary text to a recommended word depending on the user input, when the user input for selecting one of the recommended words has been received; and
control the screen to display the changed recommended word.

27. The electronic device of claim 26, wherein the controller is configured to control the screen to maintain and display the temporary text on the screen when the temporary text is a correct word.

28. The electronic device of claim 26, wherein the controller is configured to control the screen to maintain the temporary text on the screen when the user input for selecting one of the recommended words has not been received.

29. The electronic device of claim 26, wherein the controller is configured to determine that the user input for selecting the recommended word has not been received, when a user input for selecting a first key is received from the user.

30. The electronic device of claim 26, wherein the controller is configured to change the temporary text to a recommended word having a highest similarity to the temporary text among the recommended words when a user input for selecting a selection key is entered from the user, and control the screen to display the changed recommended word.
